(19) United States
(12) Patent Application Publication
(10) Pub. No.: US 2015/0318649 A1
(43) Pub. Date: Nov. 5, 2015

(54) BUS BAR ATTACHMENT STRUCTURE AND METHOD FOR MANUFACTURING BUS BAR ATTACHMENT STRUCTURE

(71) Applicant: YAZAKI CORPORATION, Tokyo (JP)

(72) Inventor: Manabu SAKAI, Shizuoka (JP)

(21) Appl. No.: 14/800,159

(22) Filed: Jul. 15, 2015

Related U.S. Application Data
(63) Continuation of application No. PCT/JP2013/084914, filed on Dec. 26, 2013.

(30) Foreign Application Priority Data
Jan. 18, 2013 (JP) 2013-007512

(51) Int. Cl. H01R 25/16; H01R 43/26

(52) U.S. Cl. CPC H01R 25/162; H01R 43/26

(57) ABSTRACT

A bus bar attachment structure includes a coupling bus bar and an attachment member for the coupling bus bar. The coupling bus bar includes a plurality of bus bars which serves as a conductive path and a coupler which integrally couples the plurality of bus bars. The coupler includes a first notch that divides the coupler from the bus bar and a second notch that bends the coupler divided from the bus bar such that the coupler is separated from the bus bar.

### CROSS REFERENCE TO RELATED APPLICATIONS

This application is a continuation application of International Application No. PCT/JP2013/084914, filed on Dec. 26, 2013, which claims priority to Japanese Patent Application No. 2013-007512, filed on Jan. 18, 2013, the entire contents of which are incorporated by references herein.

### BACKGROUND

1. Technical Field

The present invention relates to a bus bar attachment structure in which after a coupling bus bar having a plurality of bus bars integrally coupled by couplers is arranged in an attachment member, the couplers are divided and a method for manufacturing a bus bar attachment structure.

2. Description of the Related Art

Conventionally, some devices each incorporating an electrical circuit, such as an indoor lighting device for a vehicle, use a bus bar. The bus bar is molded as a conductive path by a plate-shaped conductive member into a predetermined shape. When a plurality of bus bars described above is attached to an attachment member such as a housing, the plurality of bus bars is previously integrally coupled as a coupling bus bar by couplers each formed into a bridge shape. The coupling bus bar is arranged in the attachment member, and thereafter the couplers are divided, which facilitates attaching each bus bar to the attachment member (see Japanese Patent Laid-Open Publication No. 2011-195010 (Patent Literature 1)).

### SUMMARY OF THE INVENTION

In the bus bar attachment structure disclosed in Patent Literature 1, the couplers are separated from the bus bar by punching. In this case, the separated coupler itself is a conductive foreign substance. Hence, there is a possibility that in the process of the punching of the couplers, the separated couplers enter inside the bus bar attachment structure to attach to the bus bar, which may cause a short circuit between the bus bars as a result.

Patent Literature 1 also discloses a bus bar attachment structure in which the center of the coupler is divided and the divided couplers are kept coupled to the respective bus bars. In the bus bar attachment structure, in order to prevent the divided two couplers from making contact with each other, it is necessary to perform deformation such that part of the housing intervenes between the couplers, which makes the structure complicated.

The present invention has been made in view of the above. It is an object of the present invention to provide a bus bar attachment structure that can prevent a short circuit of the bus bar with a simple structure and a method for manufacturing the bus bar attachment structure.

A first aspect of the present invention is a bus bar attachment structure, comprising: a coupling bus bar including a plurality of bus bars and a coupler, each bus bar serving as a conductive path, and the coupler being configured to integrally couple the plurality of bus bars; and an attachment member for the plurality of bus bars, wherein the coupler is provided between a first bus bar and a second bus bar of the plurality of bus bars, and the coupler includes: a first end portion connected to the first bus bar; a second end portion connected to the second bus bar; a first notch formed in the first end portion to divide the coupler from the first bus bar with the coupling bus bar attached to the attachment member; and a second notch formed in the second end portion to bend the coupler such that the coupler divided from the first bus bar is separated from the first bus bar.

A second aspect of the present invention is a method for manufacturing a bus bar attachment structure, the bus bar attachment structure including: a coupling bus bar including a plurality of bus bars and a coupler, each bus bar serving as a conductive path, and the coupler being configured to integrally couple the plurality of bus bars and including a first end portion connected to a first bus bar of the plurality of bus bars and a second end portion connected to a second bus bar of the plurality of bus bars; and an attachment member for the plurality of bus bars, the method comprising: a notch forming step including forming a first notch in the first end portion of the coupler and forming a second notch in the second end portion of the coupler; and a coupler dividing step including dividing the coupler from the first bus bar in a position where the first notch is formed with the coupling bus bar attached to the attachment member and bending the coupler in a position where the second notch is formed such that the coupler is separated from the first bus bar.

The second notch may be formed in a part on which a tensile stress or a compression stress caused by the bending of the coupler significantly acts.

According to the present invention, it is possible to provide a bus bar attachment structure that can prevent a short circuit of the bus bar with a simple structure and a method for manufacturing the bus bar attachment structure.

### BRIEF DESCRIPTION OF THE DRAWINGS

FIG. 1 is an exploded perspective view of an indoor lighting device for a vehicle (hereinafter referred to as a “lighting device” for ease of description) that incorporates a bus bar attachment structure according to an embodiment of the present invention;

FIG. 2 is a diagram when the lighting device shown in FIG. 1 is seen from the side of a lens;

FIG. 3A is a diagram when the lighting device shown in FIG. 1 is seen from the back side;

FIG. 3B is an enlarged view of the vicinity of a fixing through hole of a bus bar shown in FIG. 3A;

FIG. 4A is an enlarged perspective view of the vicinity of a coupler before the coupler of a coupling bus bar is divided;

FIG. 4B is an enlarged perspective view of the vicinity of the coupler after the coupler is divided;

FIG. 5A is a diagram showing the procedure of manufacturing a lighting device according to the embodiment of the present invention;

FIG. 5B is a diagram showing the procedure of manufacturing the lighting device according to the embodiment of the present invention;

FIG. 5C is a diagram showing the procedure of manufacturing the lighting device according to the embodiment of the present invention;

FIG. 5D is a diagram showing the procedure of manufacturing the lighting device according to the embodiment of the present invention;

FIG. 5E is a diagram showing the procedure of manufacturing the lighting device according to the embodiment of the present invention;

FIG. 5F is a diagram showing the procedure of manufacturing the lighting device according to the embodiment of the present invention;

FIG. 6A is a diagram showing, together with a coupler dividing jig, an enlarged side view of the vicinity of the coupler before the coupler of the coupling bus bar is divided;

FIG. 6B is a diagram showing, together with the coupler dividing jig, an enlarged side view of the vicinity of the coupler after the coupler is divided;

FIG. 7 is a top view of the vicinity of a coupler of a bus bar attachment structure according to a variation of the embodiment of the present invention;

FIG. 8A is an enlarged view of the vicinity of the coupler before the coupler of the coupling bus bar is divided; and

FIG. 8B is an enlarged view of the vicinity of the coupler after the coupler is divided.

### DESCRIPTION OF THE EMBODIMENTS

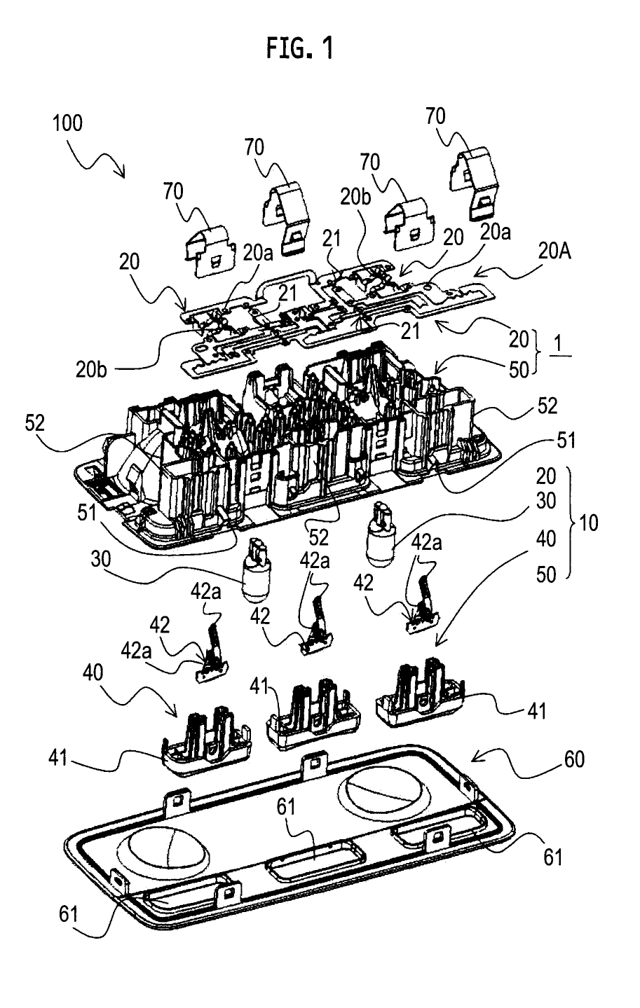

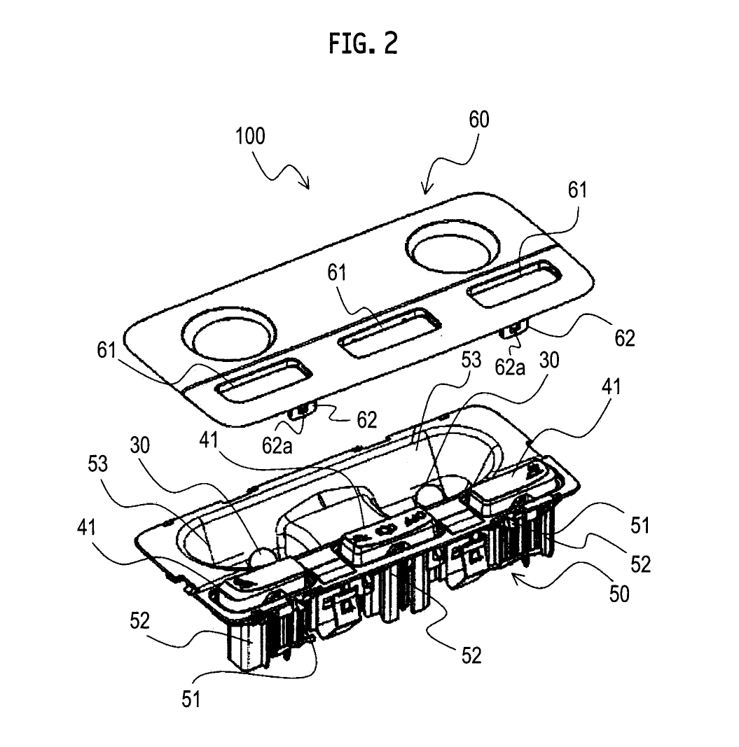

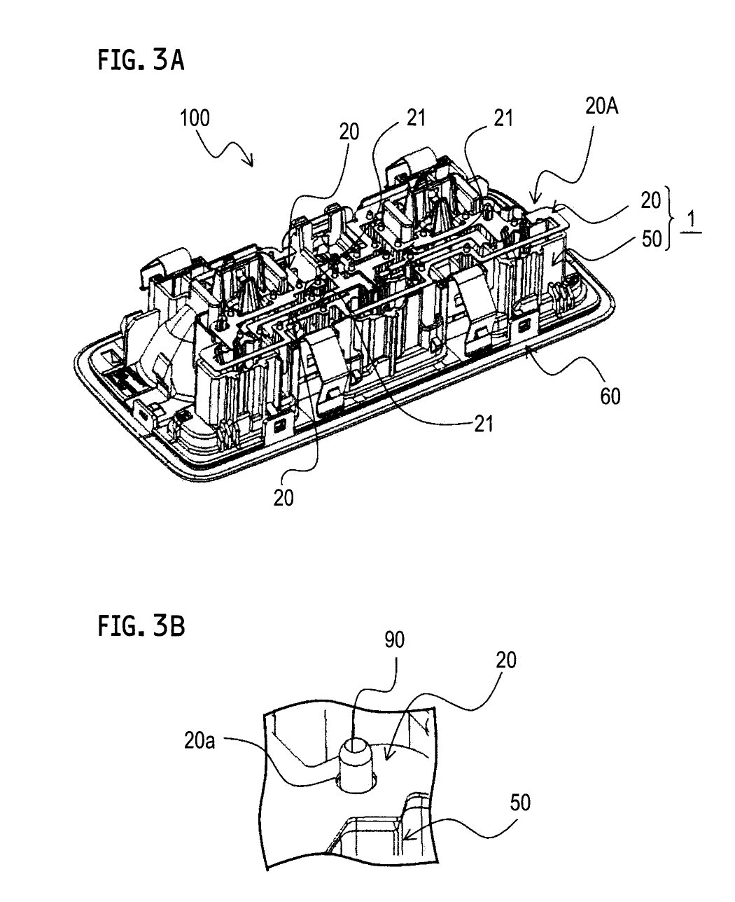

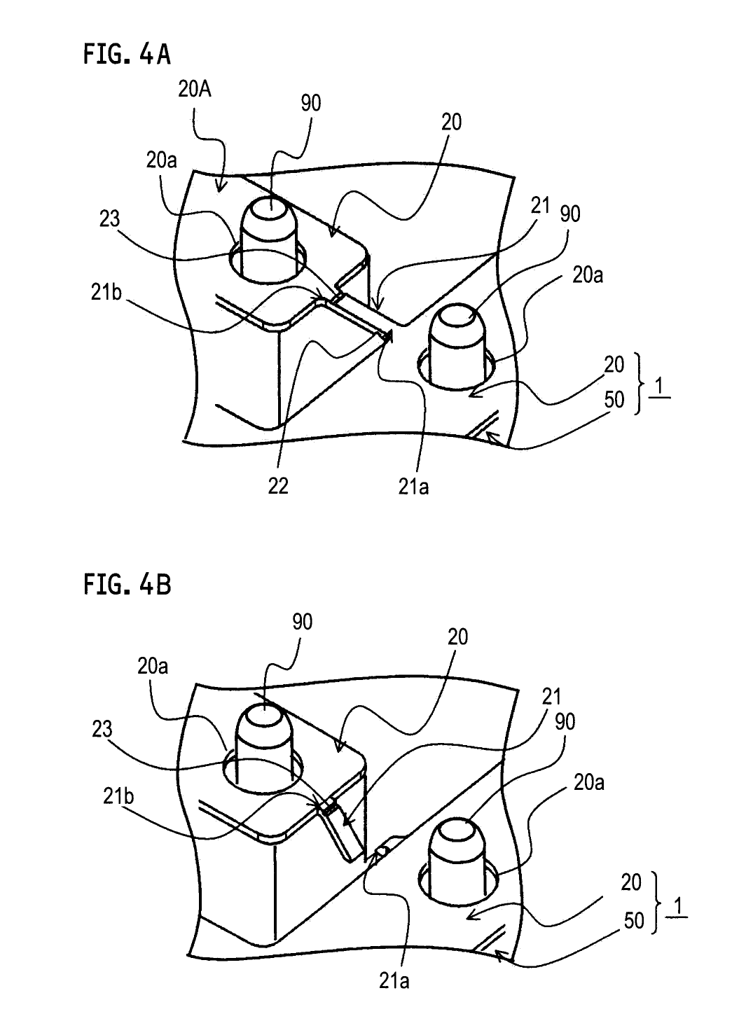

A bus bar attachment structure and a method for manufacturing the bus bar attachment structure according to an embodiment of the present invention will be described below with reference to drawings. FIG. 1 is an exploded perspective view of an indoor lighting device for a vehicle (hereinafter referred to as a “lighting device” for ease of description) 100 that incorporates the bus bar attachment structure according to the present embodiment. FIG. 2 is a diagram when the lighting device 100 shown in FIG. 1 is seen from the side of a lens 60. FIG. 3A is a diagram when the lighting device 100 shown in FIG. 1 is seen from the back side. FIG. 3B is an enlarged view of the vicinity of a fixing through hole 20a of a bus bar 20 shown in FIG. 3A. FIG. 4A is an enlarged perspective view of the vicinity of a coupler 21 before the coupler 21 of a coupling bus bar 20A is divided. FIG. 4B is an enlarged perspective view of the vicinity of the coupler 21 after the coupler 21 is divided. The bus bar attachment structure 1 according to the present embodiment is incorporated into the lighting device 100. The bus bar attachment structure 1 includes a plurality of bus bars 20 serving as a conductive path and a housing 50 serving as an attachment member for the plurality of bus bars. Each of the bus bars 20 is formed by molding, for example, a plate-shaped conductive member into a predetermined shape. The plurality of bus bars 20 is previously integrally coupled as the coupling bus bar 20A by the couplers 21. The coupling bus bar 20A is arranged in the housing 50, and thereafter the couplers 21 are divided.

The lighting device 100 will be described below. The lighting device 100 includes a lighting function portion 10 and a lens 60 serving as a design portion. The lighting function portion 10 includes the plurality of bus bars 20 serving as a conductive path, two bulbs 30 serving as a light source, three switch members 40 serving as a switching operating unit corresponding to the operation mode of the lighting and the housing 50 to which the bus bars 20, the bulbs 30 and the switch members 40 are attached. The bus bars 20, the bulbs 30 and the switch members 40 are electrically connected to operate as the lighting device.

Each of the bus bars 20 is a conductive path formed with a metal plate having conductivity. Each of the bus bars 20 is molded by, for example, punching the metal plate with a press device or the like into a predetermined shape and performing bending processing thereon to mold it into a bridge shape (bar shape, an elongated plate shape). The plurality of bus bars 20, together with the couplers 21 that integrally couple them, forms the coupling bus bar 20A. The bus bars 20 are collectively arranged in the housing 50 by dividing the couplers 21 after the coupling bus bar 20A is arranged in the housing 50. In the coupling bus bar 20A, a plurality of through holes 20a is formed. Welding pins 90 that are provided in a plurality of places of the housing 50 are inserted through the through holes 20a. The welding pins 90 are welded into the coupling bus bar 20A while being inserted into the through holes 20a. Consequently, the coupling bus bar 20A is positioned and fixed to the housing 50.

As shown in FIG. 4A, the coupler 21 includes one end portion (first end portion) 21a that is connected to one bus bar 20 (first bus bar) and the other end portion (second end portion) 21b that is connected to the other bus bar 20 (second bus bar). In the end portion 21a, a notch (first notch) 22 for dividing the coupler 21 is formed. In the end portion 21b, a notch (second notch) 23 for bending the coupler 21 is formed.

The notch 22 is formed along the width direction of the coupler 21, in the back surface of a surface onto which a jig (which will be described later) 80 for dividing the coupler 21 is pressed. Although the cross section of the notch 22 is, for example, V-shaped, any other shape may be formed. A pointed top end 81 of the jig 80 is pressed onto the back surface, and thus as shown in FIG. 4B, the end portion 21a is divided in a position where the notch 22 is formed.

The notch 23 is formed along the width direction of the coupler 21, in the surface onto which the jig 80 is pressed. Although the cross section of the notch 22 is, for example, V-shaped, any other shape may be formed. The inclined surface portion 82 of the jig 80 is pressed onto the area between the notch 23 and the notch 22, and thus the divided coupler 21 is bent in the position where the notch 23 is formed such that it is separated from the one bus bar (first bus bar) 20. In other words, the end portion 21b of the coupler 21 is bent in the position where the notch 23 is formed such that the divided coupler 21 approaches the other bus bar (second bus bar) 20.

The cross-sectional area of the part of the coupler 21 where the notch 23 is formed is smaller than that of its vicinity. In other words, when the part where the notch 23 is formed is bent, the cross-sectional area of the bent part to which the reaction force of a compression stress and the reaction force of a tensile stress are applied is relatively smaller than that of its vicinity. Hence, the notch 23 is formed, and thus it is possible to reduce a so-called springback by which the coupler 21 is returned to its original form.

In general, when an object is bent, a tensile stress significantly acts on the outside part of the bent part. In the coupler 21 of the present embodiment, the notch 23 is formed in the outside part. Hence, it is possible to effectively reduce the reaction force of the tensile stress and to maintain the bending of the coupler 21. The notch 23 may be formed in the back surface of the surface onto which the jig 80 is pressed. In this case, since the notch 23 is formed in the inside part of the bent part, it is possible to effectively reduce the reaction force of the compression stress and to maintain the bending of the coupler 21.

The bulb 30 is a light source. The bulb 30 is turned on and off based on a control signal by the switching operation of a switch operating portion (which will be described later) 41. As shown in FIG. 2, the bulbs 30 are arranged on the bottom surface of mortar-shaped portions 53 formed in two places on the side of a design surface of the housing 50. The bulbs 30 are electrically connected to bulb connection terminals 20b formed in the bus bars 20 within the housing 50.

Each of the switch members 40 includes the switch operating portion 41 that is operated by a user and a switch terminal 42 that includes a pair of contact portions 42a which moves together with the switch operating portion 41. In the present embodiment, three switch members 40 are provided such that the mode is switched to any one of three types of operating modes (such as a turning-on mode and a turning-off mode) in the lighting device 100.

The housing 50 forms the outline of the lighting device 100 together with the lens 60. The housing 50 is formed with a resin member. The lens 60 is assembled to the side of the design surface of the housing 50. The individual portions of the lighting function portion 10 are attached to the housing 50.

In other words, the housing 50 is an attachment member of the bus bar 20 in the bus bar attachment structure 1. As described above, the housing 50 includes the welding pins 90 for positioning and fixing the coupling bus bar 20A to the housing 50.

The surface of the housing 50 on the side to which the lens 60 is attached has an outside shape corresponding to the shape of the lens 60. Along the outer peripheral edge of the housing 50, a plurality of locking protrusions 51 is provided. The locking protrusions 51 engage with the locking holes 62a of locking pieces 62 provided on the lens 60. Furthermore, in three places of the housing 50 along the longitudinal direction, switch member attachment portions 52 to which the switch members 40 are attached are provided.

The lens 60 converges or diverges light emitted from the bulbs 30. The lens 60 is formed with a resin member, and forms the design surface of the lighting device 100. The lens 60 has, for example, a rectangular outside shape. In three places of the lens 60 along the longitudinal direction, operation opening portions 61 are formed. The operation opening portions 61 are opened such that the switch operating portions 41 are exposed to the side of the design surface. A metal clip 70 is formed with an elastic metal plate that is bent in the shape of a letter U. The elastic metal plate is, for example, a stainless plate. The metal clip 70 functions as a fixing member for fixing the lighting device 100 to a vehicle.

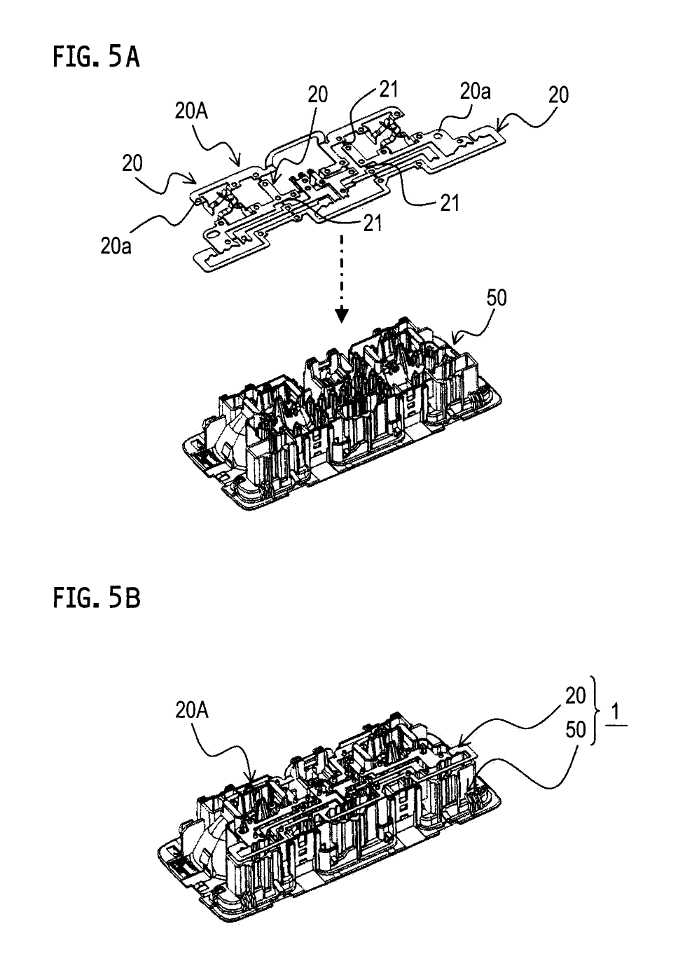

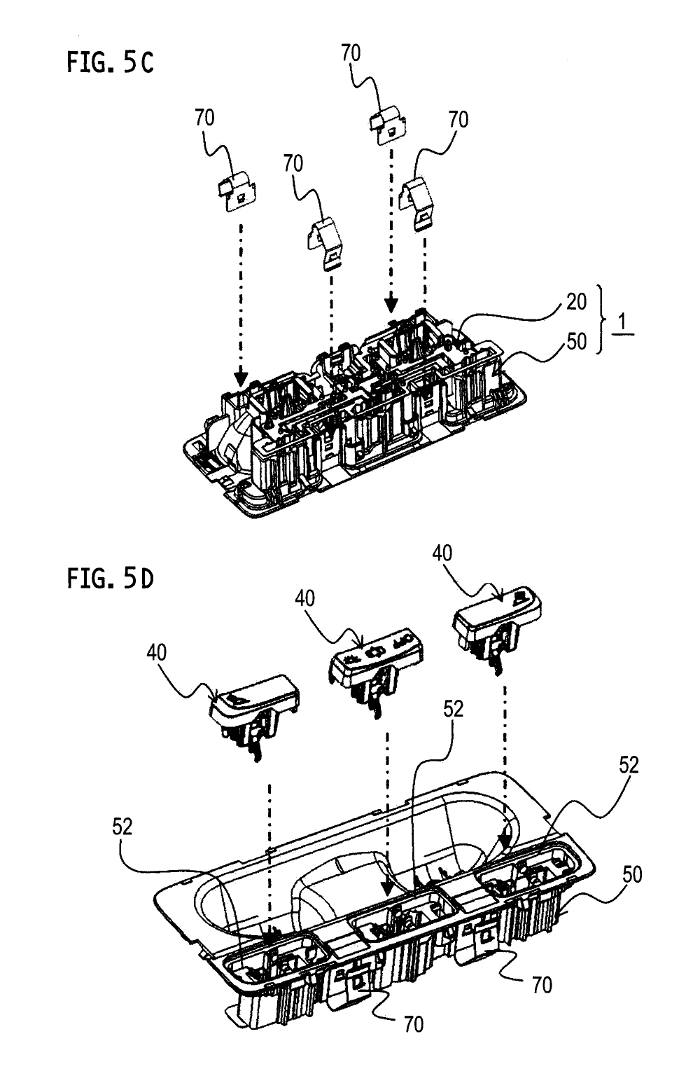

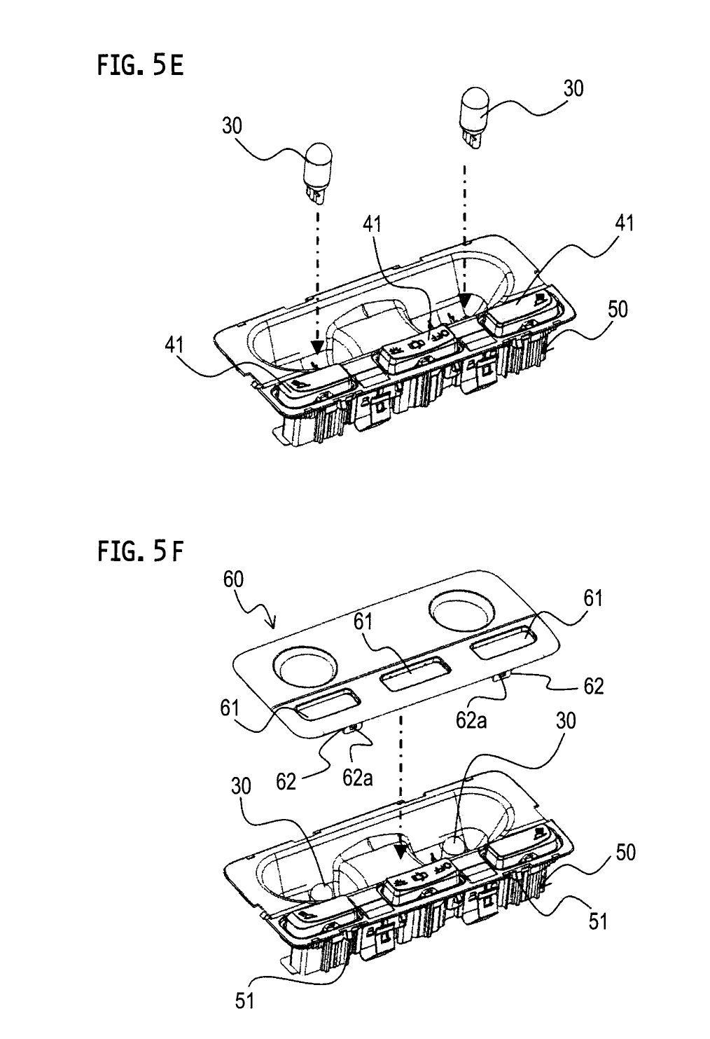

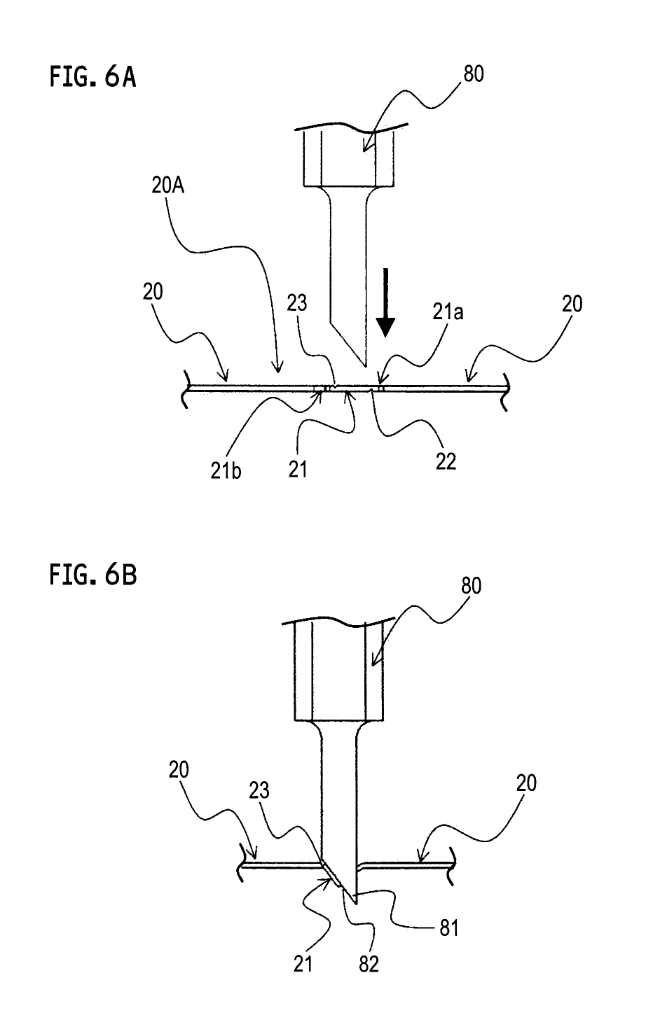

A method of manufacturing the lighting device 100 including the bus bar attachment structure 1 will be described with reference to FIGS. 5A to 5F. FIGS. 5A to 5F are diagrams showing the procedure of manufacturing the lighting device 100. FIG. 6A is a diagram showing, together with the coupler dividing jig 80, an enlarged side view of the vicinity of the coupler 21 before the coupler 21 of the coupling bus bar 20A is divided. FIG. 6B is a diagram showing, together with the coupler dividing jig 80, an enlarged side view of the vicinity of the coupler 21 after the coupler 21 is divided. In FIGS. 6A and 6B, the illustration of the housing 50 is omitted.

An operator first attaches the coupling bus bar 20A to the housing 50 (see FIGS. 5A and 5B). In this step, the operator arranges the coupling bus bar 20A in the housing 50 such that the welding pins 90 are inserted through the corresponding through holes 20a. In other words, the coupling bus bar 20A is positioned in a predetermined position of the housing 50. Thereafter, the coupling bus bar 20A is fixed to the housing 50 by the welding of the welding pins 90. In this way, the plurality of bus bars 20 is collectively attached to the housing 50.

Thereafter, the operator uses the jig 80 to divide the couplers 21. In other words, the coupling bus bar 20A is divided into the plurality of bus bars 20 (see FIGS. 6A and 6B). In this step, as shown in FIGS. 4A and 4B, the end portion 21b of each of the couplers 21 is bent in the position where the notch 23 is formed such that the end portion 21a is divided in the position where the notch 22 is formed and that the end portion 21a is separated from the bus bar (first bus bar) 20 divided from the coupler 21. The jig 80 used in this step includes a top end portion 81 having a pointed shape for dividing the couplers 21 and an inclination portion 82 having an inclined surface for defining the bending angle of the bent part of the coupler 21.

Thereafter, the operator attaches the metal clips 70 and the switch members 40 to the housing 50 (see FIGS. 5C and 5D).

Furthermore, the operator attaches the bulbs 30 to the housing 50, then finally attaches the lens 60 to complete the assembly of the lighting device 100 (see FIGS. 5E and 5F).

In the present embodiment, the notch 23 is formed in the end portion 21b located on the side opposite to the end portion 21a divided from the bus bar (first bus bar) 20. The notch 23 can bend the coupler 21 with the coupler 21 coupled to the bus bar (second bus bar) 20 on the side of the end portion 21b. In other words, even when the coupler 21 is divided and bent, the coupler 21 is not separated from the bus bar 20, and thus the coupler 21 itself does not become a conductive foreign substance. The cross-sectional area of the part where the notch 23 is formed is smaller than that of the part of its vicinity. When the coupler 21 is bent, the reaction force of the compression stress and the reaction force of the tensile stress are applied to the bent part and the part of its vicinity. However, since the cross-sectional area of the bent part is relatively smaller than that of the part of its vicinity, the bent part is unlikely to be returned to its original shape, and the springback of the couplers 21 is reduced. In other words, it is possible to prevent a short circuit of the bus bar with a simple structure.

The notch 23 is formed in the part on which the tensile stress or the compression stress caused by the bending of the couplers 21 act. Hence, it is possible to effectively reduce the reaction force of the tensile stress or the reaction force of the compression stress and to effectively reduce the springback of the coupler 21.

(Variation)

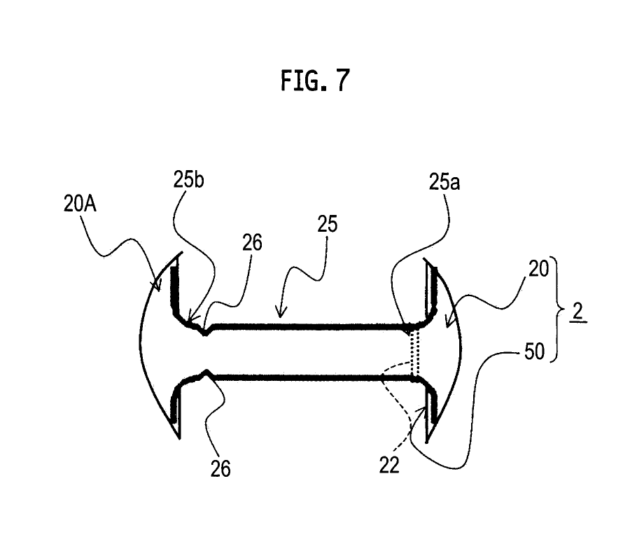

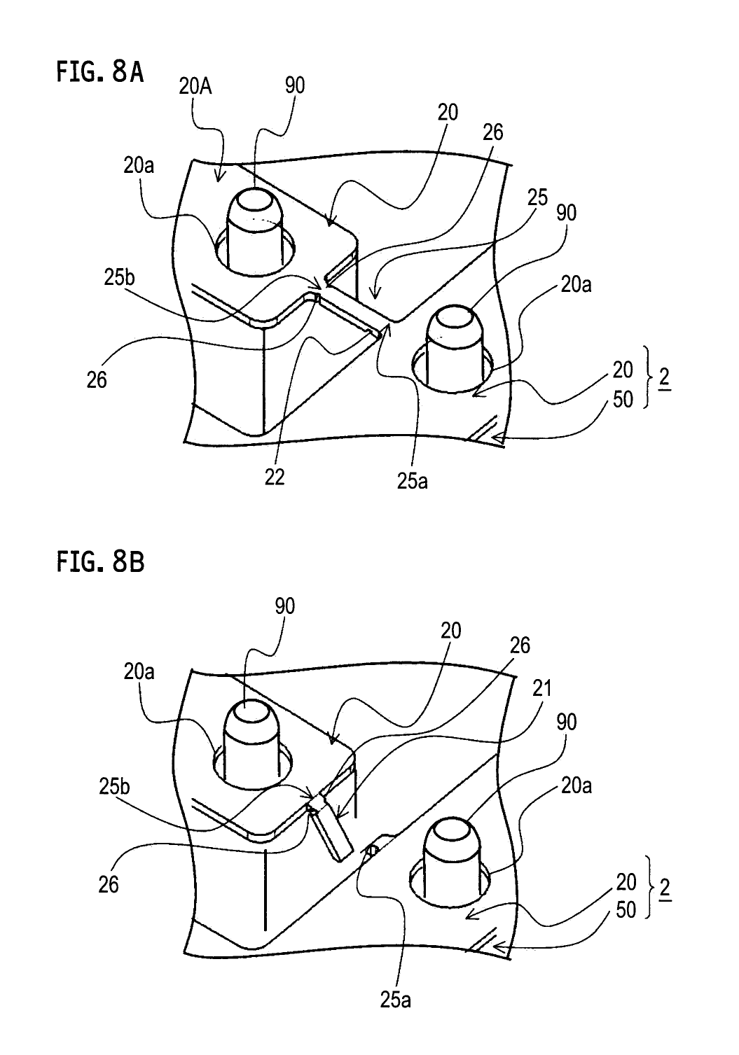

A variation of the present embodiment will then be described with reference to FIGS. 7, 8A and 8B. FIG. 7 is a top view of the vicinity of a coupler 25 of a bus bar attachment structure 2 according to the variation of the present embodiment. FIG. 8A is an enlarged view of the vicinity of the coupler 25 before the coupler 25 of the coupling bus bar 20A is divided. FIG. 8B is an enlarged view of the vicinity of the coupler 25 after the coupler 25 is divided. As shown in FIG. 7, the bus bar attachment structure 2 differs from the bus bar attachment structure 1 described above in that it includes the coupler 25 where a pair of notches 26, 26 is formed. The notches 26 are formed in both side surfaces of the coupler 25 to extend in the width direction thereof. The other configurations are the same as in the embodiment, and the same constituent parts as in the embodiment are identified with the same symbols.

In the coupler 25 of the variation, the cross-sectional area of the part where the pair of notches 26, 26 is formed is also smaller than that of the vicinity thereof. Hence, when the part where the notches 26, 26 are formed is bent, the cross-sectional area of the bent part to which the reaction force of the compression stress and the reaction force of the tensile stress are applied is relatively smaller than that of the vicinity thereof. Consequently, as in the embodiment described above, the springback of the coupler 25 is reduced.

In the variation, the notches 26, 26 are also formed in an end portion 25b located on the side opposite to an end portion 25a divided from the bus bar (first bus bar) 20. The notches 26, 26 can bend the coupler 25 with the coupler 25 coupled to the bus bar (second bus bar) 20 on the side of the end portion 25b. In other words, even when the coupler 25 is divided and bent, the coupler 25 is not separated from the bus bar 20, and thus the coupler 25 itself does not become a conductive foreign substance. The cross-sectional area of the part where the notch 26 is formed is smaller than that of the vicinity. When the coupler 25 is bent, the reaction force of the compression stress and the reaction force of the tensile stress are applied to the bent part and the part of its vicinity. However, since the cross-sectional area of the bent part is relatively smaller than that of the part of its vicinity, the bent part is unlikely to be returned to its original shape, and the springback of the coupler 25 is reduced. In other words, it is possible to prevent a short circuit of the bus bar with a simple structure.

Although the example where the bus bar attachment structures 1 and 2 according to the embodiment of the present invention are incorporated in the lighting device 100 has been described, there is no restriction on this, and a structure where a plurality of bus bars 20 is attached to an attachment member such as the housing 50 may be incorporated in any other device. For example, the bus bar attachment structures 1 and 2 may be incorporated into a so-called electrical connection box mounted on an automobile or the like.

Although the example where the indoor lighting device for a vehicle including the bus bar attachment structures 1 and 2 according to the embodiment of the present invention is manufactured manually with the coupler dividing jig 80 by the operator has been descried, there is no restriction on this, and it may be automatically manufactured with a press machine or the like.

Although the present invention has been described above by reference to the embodiments and the example, the present invention is not limited to those, and it will be apparent to these skilled in the art that various modifications and improvements can be made.

What is claimed is:

1. A bus bar attachment structure, comprising:
a coupling bus bar including a plurality of bus bars and a coupler, each bus bar serving as a conductive path, and the coupler being configured to integrally couple the plurality of bus bars; and
an attachment member for the plurality of bus bars, wherein
the coupler is provided between a first bus bar and a second bus bar of the plurality of bus bars, and
the coupler includes:
a first end portion connected to the first bus bar;
a second end portion connected to the second bus bar;
a first notch formed in the first end portion to divide the coupler from the first bus bar with the coupling bus bar attached to the attachment member; and
a second notch formed in the second end portion to bend the coupler such that the coupler divided from the first bus bar is separated from the first bus bar.

2. The bus bar attachment structure according to claim 1, wherein the second notch is formed in a part on which a tensile stress or a compression stress caused by the bending of the coupler significantly acts.

3. A method for manufacturing a bus bar attachment structure according to claim 1, the bus bar attachment structure including: a coupling bus bar including a plurality of bus bars and a coupler, each bus bar serving as a conductive path, and the coupler being configured to integrally couple the plurality of bus bars and connected to a first bus bar of the plurality of bus bars and a second end portion connected to a second bus bar of the plurality of bus bars; and an attachment member for the plurality of bus bars, the method comprising:
a notch forming step including forming a first notch in the first end portion of the coupler and forming a second notch in the second end portion of the coupler; and
a coupler dividing step including dividing the coupler from the first bus bar in a position where the first notch is formed with the coupling bus bar attached to the attachment member and bending the coupler in a position where the second notch is formed such that the coupler is separated from the first bus bar.

4. The method for manufacturing a bus bar attachment structure according to claim 3, wherein the notch forming step forms the second notch in a part on which a tensile stress or a compression stress caused by the bending of the coupler significantly acts.
